(19) United States
(12) Patent Application Publication
(10) Pub. No.: US 2026/0028009 A1
(43) Pub. Date: Jan. 29, 2026

(54) BRAKE CONTROL APPARATUS FOR A VEHICLE TRAIN AND METHODS THEREFOR

(71) Applicant: Bendix Commercial Vehicle Systems LLC, Avon, OH (US)

(72) Inventors: Konstantinos Vilaetis, Lakewood, OH (US); Nicholas A. Broyles, North Ridgeville, OH (US); Andrew J. Pilkington, Avon Lake, OH (US)

(73) Assignee: Bendix Commercial Vehicle Systems LLC, Avon, OH (US)

(21) Appl. No.: 18/786,992

(22) Filed: Jul. 29, 2024

(51) Int. Cl. B60T 17/22; B60T 11/28

(52) U.S. Cl. CPC B60T 17/22; B60T 11/28; B60T 2270/402; B60T 2270/406; B60T 2270/413; Y10S 303/01

(57) ABSTRACT

A brake control apparatus is provided for a vehicle train having a tractor and one or more towed vehicles coupled to the tractor. The brake control apparatus comprises a tractor controller arranged to detect a pressure change in at least one brake line of the vehicle train in response to a brake trigger signal. The tractor controller is also arranged to process the detected pressure change to estimate a combination of the number of the towed vehicles and a total length of the number of towed vehicles coupled to the tractor.

### BACKGROUND

The present application relates to vehicle trains, and is particularly directed to a brake control apparatus for a vehicle train and methods therefor, such as for a vehicle train having a tractor and one or more towed vehicles coupled to the tractor.

In a typical vehicle train having a tractor and a plurality of towed vehicles coupled to the tractor, service brakes and parking brakes are sometimes tuned based upon the maximum number of towed vehicles that can be coupled to the tractor or the maximum load the vehicle train is expected to carry.

A drawback in tuning the service brakes and the parking brakes based upon the maximum number of towed vehicles is that braking performance is less than optimal when the actual number of towed vehicles is less than the maximum number of towed vehicles that can be coupled to the tractor.

Similarly, a drawback in tuning the service brakes and the parking brakes based upon the maximum expected load is that braking performance is less than optimal when the vehicle train is carrying a load that is much less than the maximum expected load. For example, no towed vehicle may be coupled to the tractor, but yet the service brakes and the parking brakes for the tractor (which is carrying no load) are tuned for the maximum expected load.

Despite advances already made, those skilled in the art continue with research and development efforts in the field of tuning service brakes and parking brakes of a vehicle train, such as a vehicle train having a tractor and a plurality of towed vehicles coupled to the tractor.

### SUMMARY

In accordance with one embodiment, a brake control apparatus is provided for a vehicle train having a tractor and one or more towed vehicles coupled to the tractor. The brake control apparatus comprises a tractor controller arranged to detect a pressure change in at least one brake line of the vehicle train in response to a brake trigger signal. The tractor controller is also arranged to process the detected pressure change to estimate a combination of the number of the towed vehicles and a total length of the number of towed vehicles coupled to the tractor.

In accordance with another embodiment, a brake control apparatus is provided for a vehicle train having a tractor and one or more towed vehicles coupled to the tractor. The brake control apparatus comprises a brake line extending between the tractor and the one or more towed vehicles. The brake control apparatus further comprises a tractor controller arranged to apply a pressure pulse in the brake line. The tractor controller is also arranged to detect a reflected pressure pulse in the brake line in response to the applied pressure pulse, and determine the number of towed vehicles coupled to the tractor based upon the reflected pressure pulse detected in the brake line.

In accordance with yet another embodiment, a method is provided of operating a vehicle train having a tractor and one or more towed vehicles coupled to the tractor. The method comprises providing a pressure change in a brake line that extends between the tractor and the one or more towed vehicles coupled to the tractor. The method also comprises detecting the pressure change provided in the brake line. The method further comprises determining a combination of towed vehicle length and the number of towed vehicles coupled to the tractor based upon the detected pressure change.

### BRIEF DESCRIPTION OF THE DRAWINGS

FIG. 1 is a pictorial diagram of a vehicle train embodying an example brake control apparatus constructed in accordance with the present disclosure.

FIGS. 2A-2I are schematic block diagrams of example tractor controllers used in the brake control apparatus of FIG. 1.

FIGS. 3A-3H are flow diagrams corresponding to the schematic block diagrams of FIGS. 2A-2H, respectively, depicting methods of operating the tractor controllers of FIGS. 2A-2H in accordance with different embodiments.

FIG. 4 is a flow diagram depicting a method of operating the vehicle train of FIG. 1 in accordance with an embodiment.

### DETAILED DESCRIPTION

The present application is directed to a brake control apparatus for a vehicle train and methods therefor, such as for a vehicle train having a tractor and one or more towed vehicles coupled to the tractor. The specific construction of the brake control apparatus may vary. It is to be understood that the disclosure below provides a number of embodiments or examples for implementing different features of various embodiments. Specific examples of components and arrangements are described to simplify the present disclosure. These are merely examples and are not intended to be limiting.

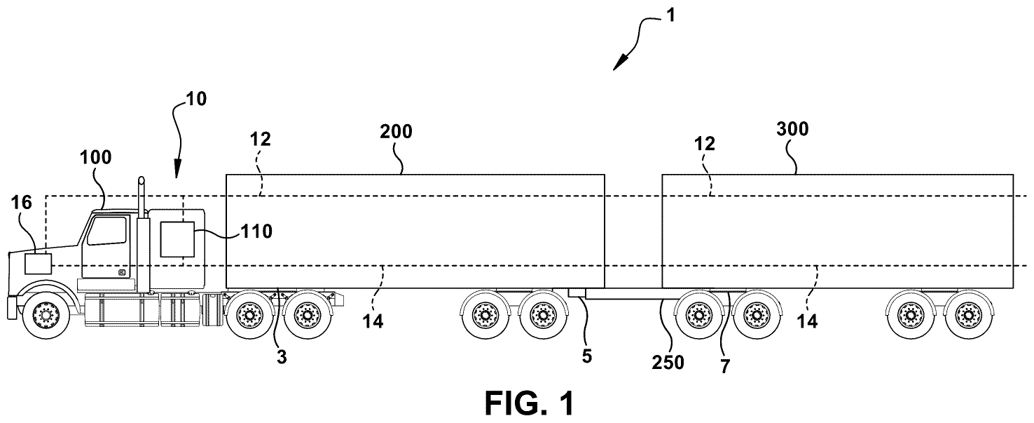

Referring to FIG. 1, a pictorial diagram is illustrated of a vehicle train 1 embodying an example brake control apparatus 10 constructed in accordance with the present disclosure. The vehicle train 1 has a tractor 100 and one or more towed vehicles including first trailer 200, dolly 250, and second trailer 300 coupled to the tractor 100. A mechanical coupling 3 mechanically interconnects the tractor 100 and the first trailer 200 in known and conventional manner. The dolly 250 includes a hook portion 5 that connects to rear end of the first trailer 200, and a plate portion 7 that connects to front end of the second trailer 300. The dolly 250 mechanically interconnects the first trailer 200 and the second trailer 300 in known and conventional manner.

Although the above description describes three towed vehicles (i.e., the first trailer 200, the dolly 250, and the second trailer 300) coupled to the tractor 100, it is conceivable that any number of towed vehicles (including zero towed vehicles) can be coupled to the tractor 100. As another example, five towed vehicles (i.e., three trailers and two dollies) may be coupled to the tractor 100.

The brake control apparatus 10 includes an electronic controller unit (ECU) 110 of the tractor 100. The ECU 110 is referred to herein as “tractor controller 110”. The tractor controller 110 is pneumatically connected to a parking brake line 12, and is pneumatically connected to a service brake line 14. Each of the parking brake line 12 and the service brake line 14 is pneumatically connected to a brake controller 16 of the vehicle train 1. The brake controller 16 controls in known and conventional manner the pneumatic pressure in the parking brake line 12 to provide parking brakes for the vehicle train 1, and the pneumatic pressure in the service brake line 14 to provide service brakes for the vehicle train 1, and therefore, will not be further described.

Network communication between controllers may comprise a controller area network (CAN) bus to which a number of vehicle devices are connected to communicate with each other. The CAN bus may be in a standardized serial communication format, such as SAE J1939, or in a proprietary format. The communication path may or may not be shown or described herein via wired (e.g., controller area network (CAN), ethernet, automotive ethernet, etc.) or wireless (e.g., Wi-Fi, Bluetooth, cellular, etc.) connections. Other types of network communication are possible.

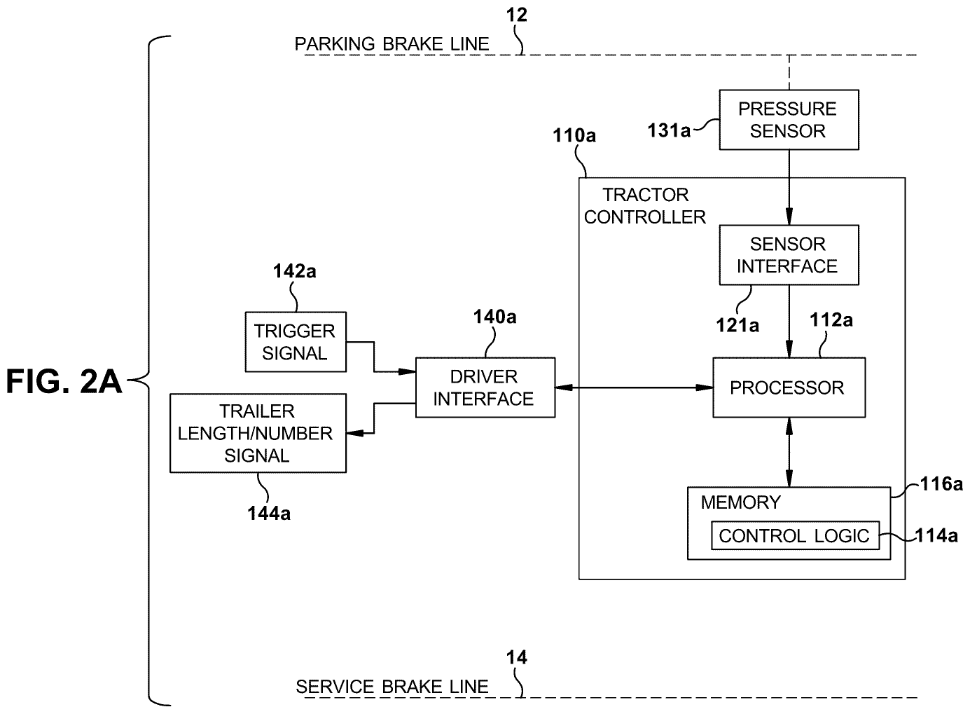

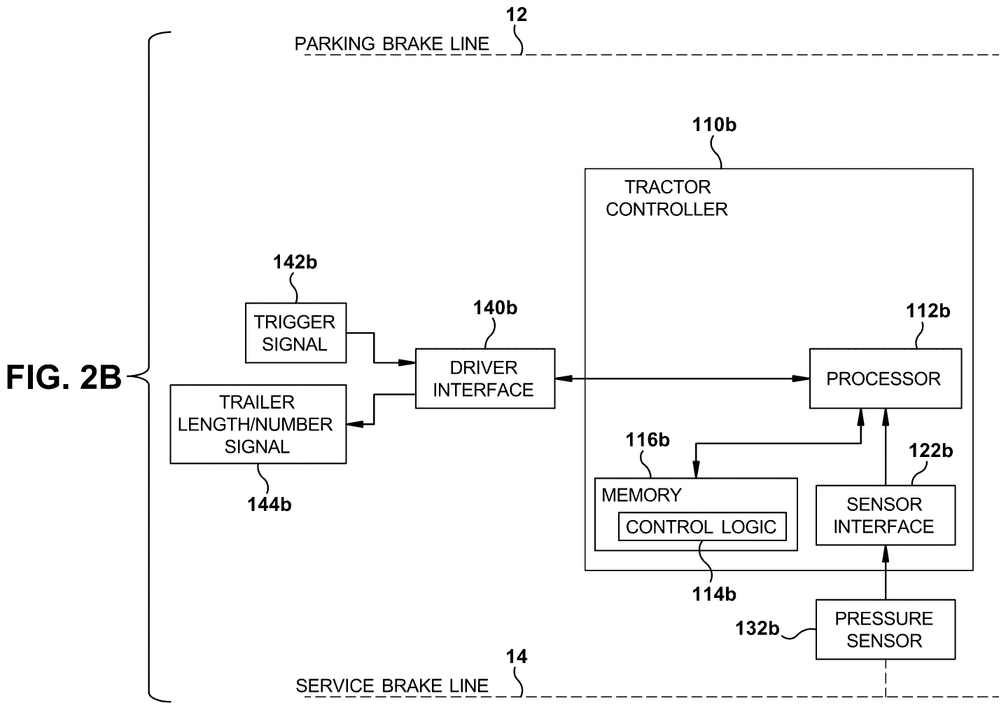

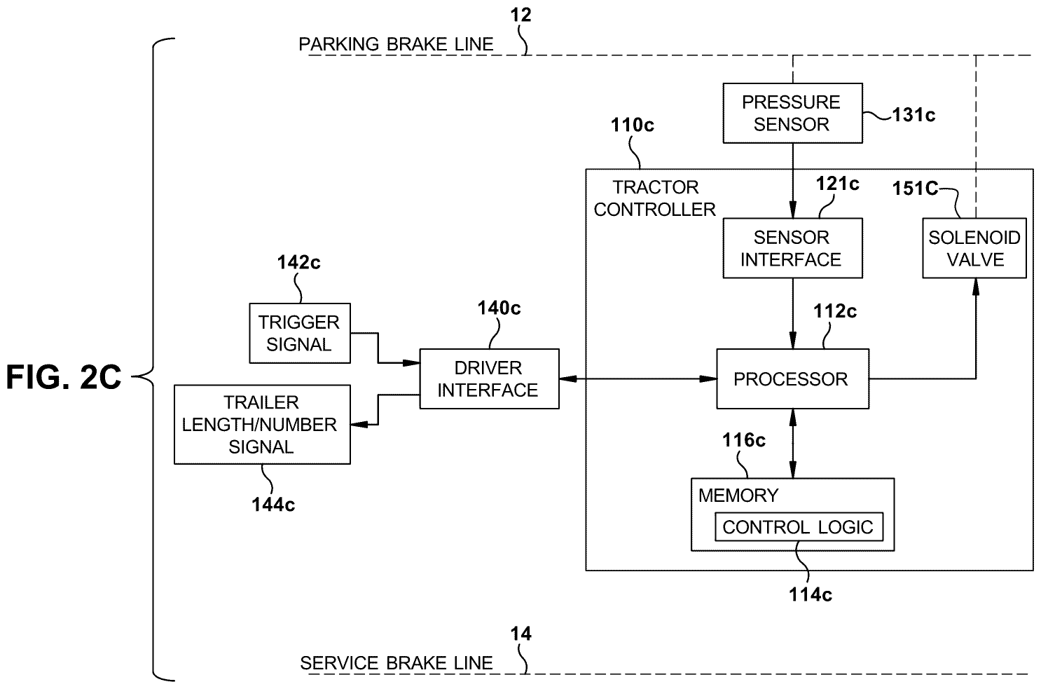

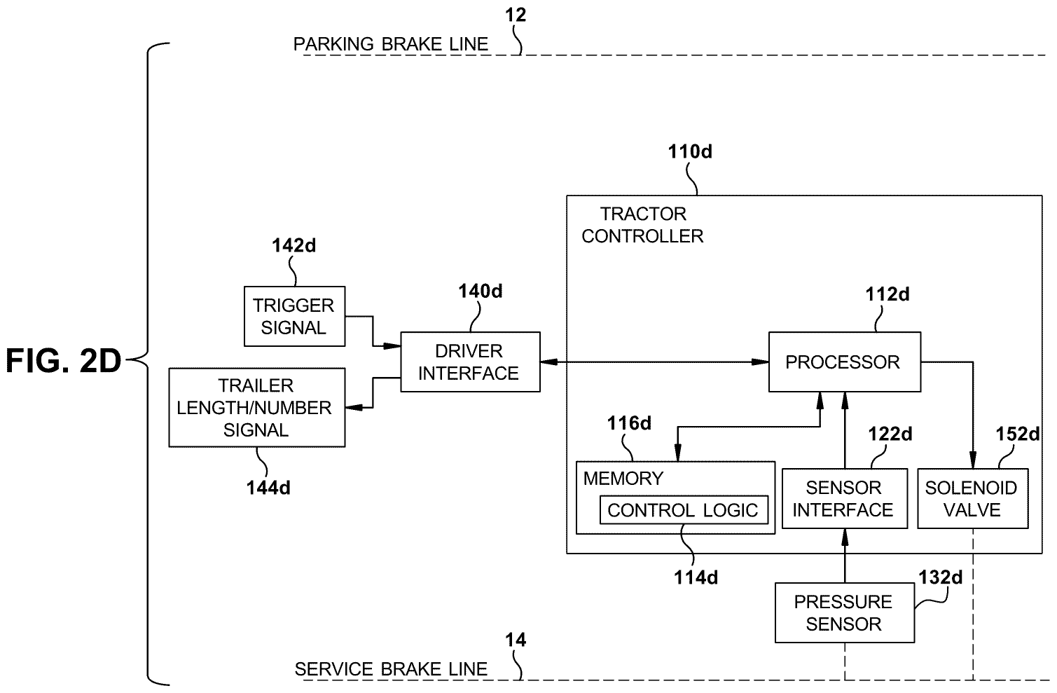

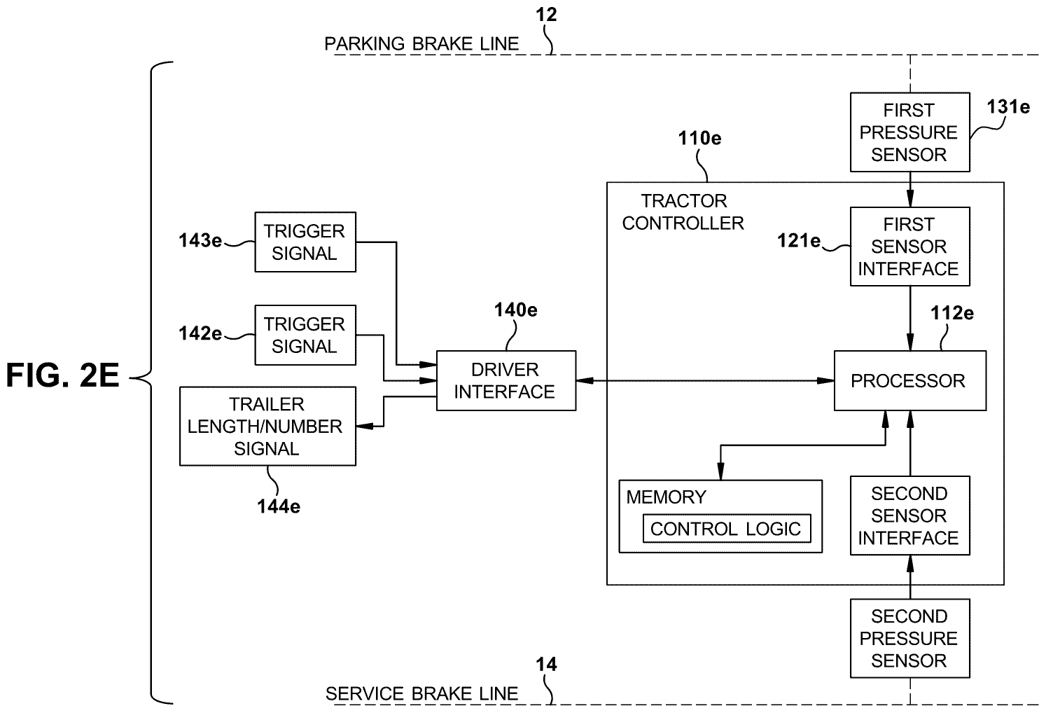

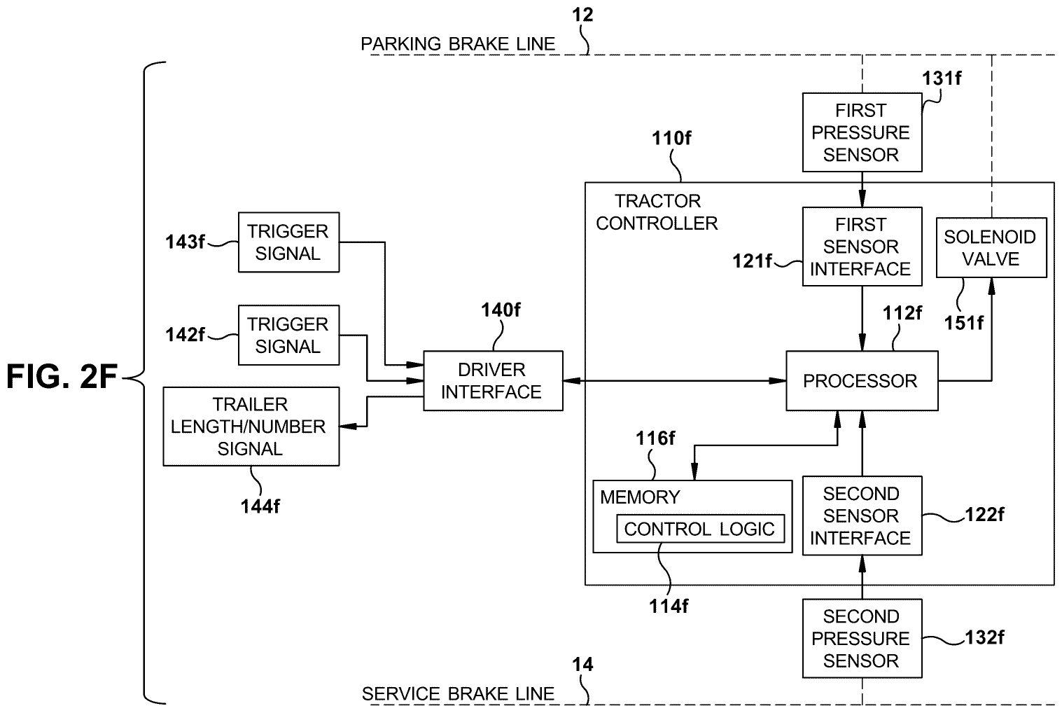

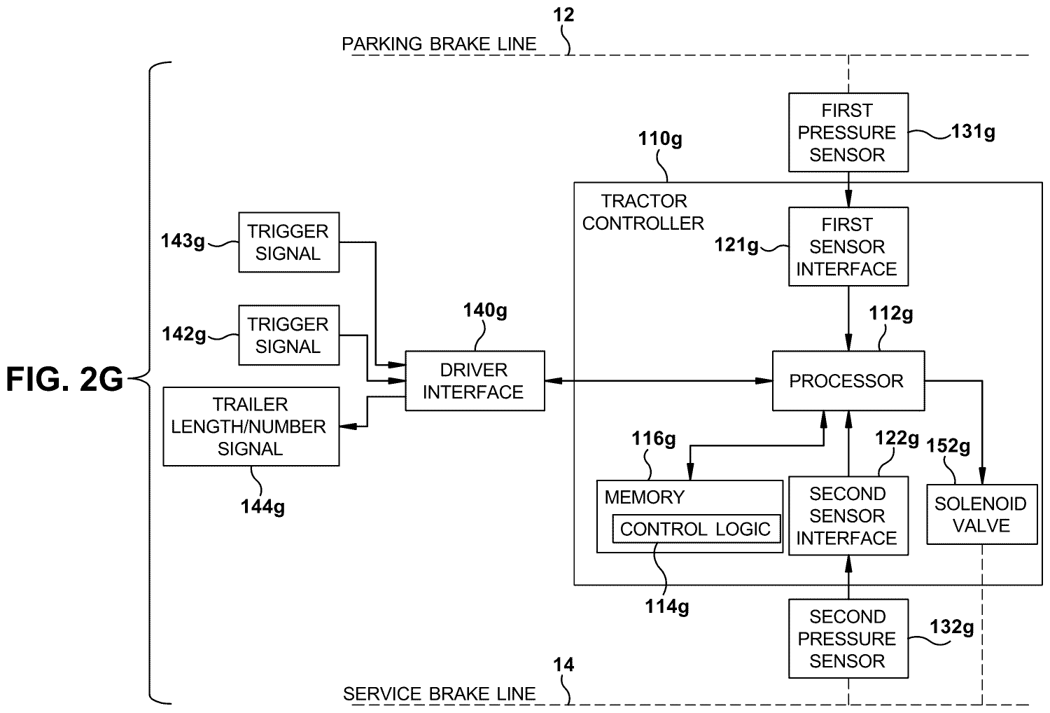

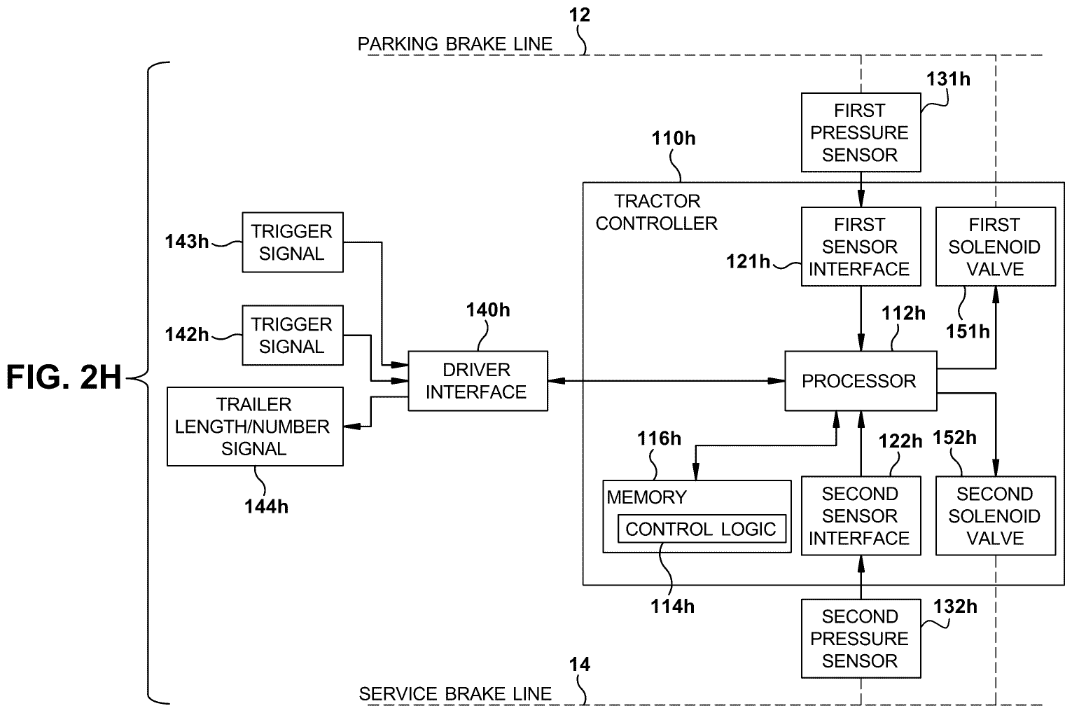

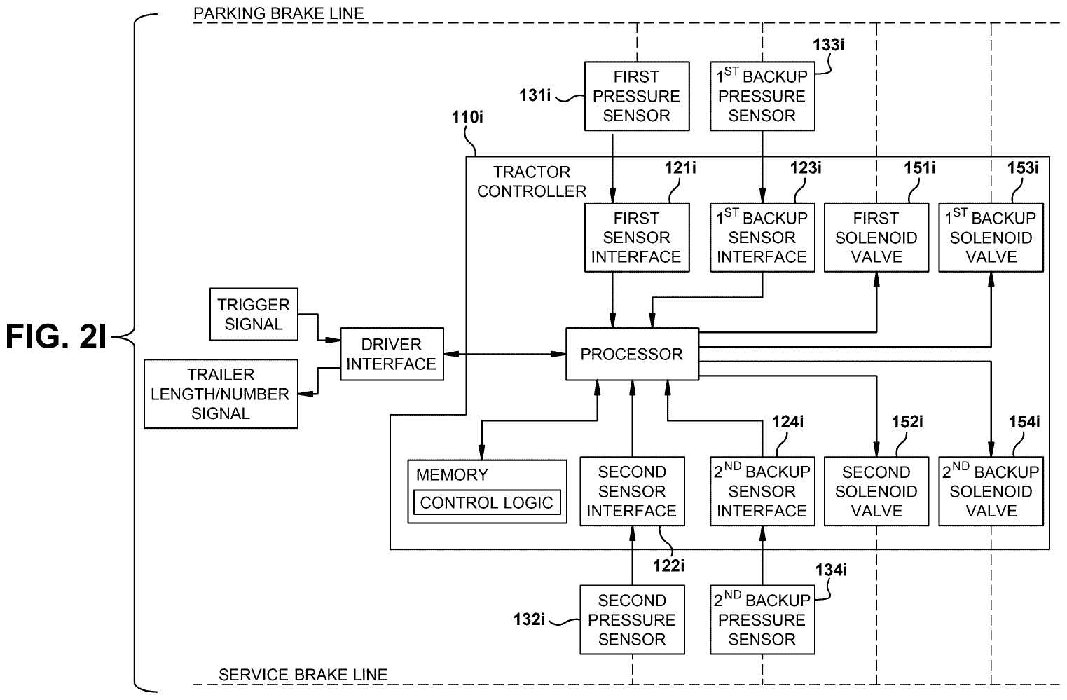

Referring to FIG. 2A, a schematic block diagram of an example tractor controller 110a (corresponding to tractor controller 110 of FIG. 1) in accordance with an embodiment is illustrated. Tractor controller 110a includes processor 112a that executes instructions of control logic 114a stored in internal memory 116a, external memory (not shown), or a combination thereof. Processor 112a may comprise any type of technology. For example, processor 112a may comprise a general-purpose electronic processor. Other types of processors and technologies are possible. Internal memory 116a may comprise any type of technology. For example, internal memory 116a may comprise random access memory (RAM), read only memory (ROM), solid state memory, or any combination thereof. Other types of memories and data storage technologies are possible.

Tractor controller 110a also includes vehicle sensor interface 121a that may comprise any type of technology. Sensor interface 121a enables communication between processor 112a and pressure sensor 131a, which is a transducer that detects pressure in parking brake line 12. Tractor controller 110a communicates with vehicle driver interface 140a that may comprise any type of technology. Driver interface 140a enables communication between processor 112a and any combination of driver input devices and driver output devices (not shown) located in the vehicle driver compartment.

Driver input devices may comprise a parking brake handle for enabling the vehicle driver to apply/release parking brakes of the vehicle train 1 (FIG. 1), and a foot pedal for enabling the vehicle driver to apply/release the service brakes of the vehicle train 1. Other types of driver input devices and technologies are possible. As shown in FIG. 2A, driver interface 140a receives trigger signal 142a (from either the parking brake handle or the foot pedal, for example) that is communicated to processor 112a for further processing.

Driver output devices may comprise a display for enabling the vehicle information from processor 112a to be presented to the vehicle driver in the vehicle driver compartment. As shown in FIG. 2A, processor 112a provides trailer length/number signal 144a via driver interface 140a to the display in the vehicle driver compartment. Trailer length/number signal 144a is indicative of a combination of the number of trailers and a total length of the number of trailers (e.g., the first trailer 200 and/or the second trailer 300 shown in FIG. 1) coupled to the tractor 100.

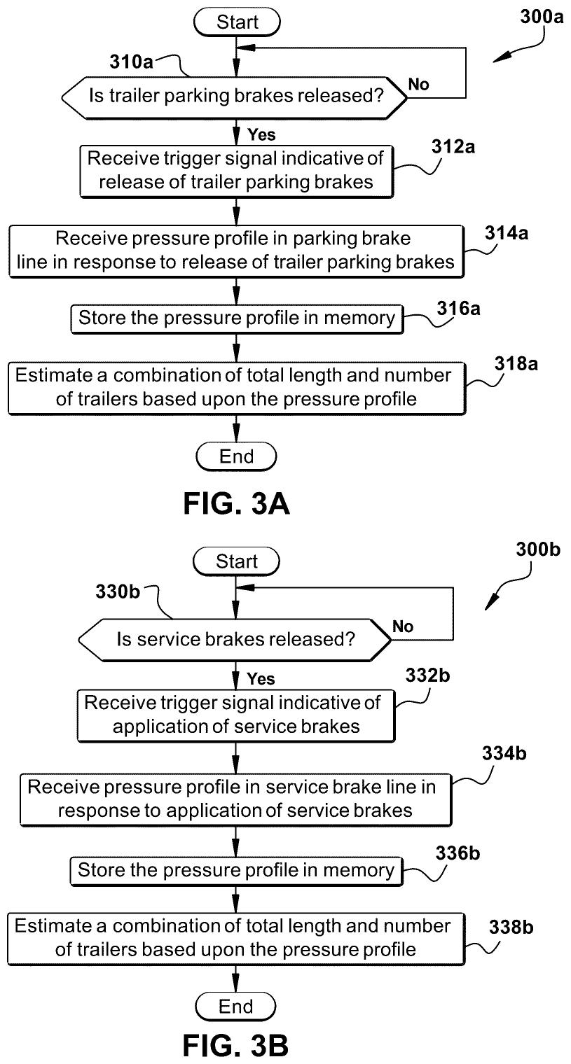

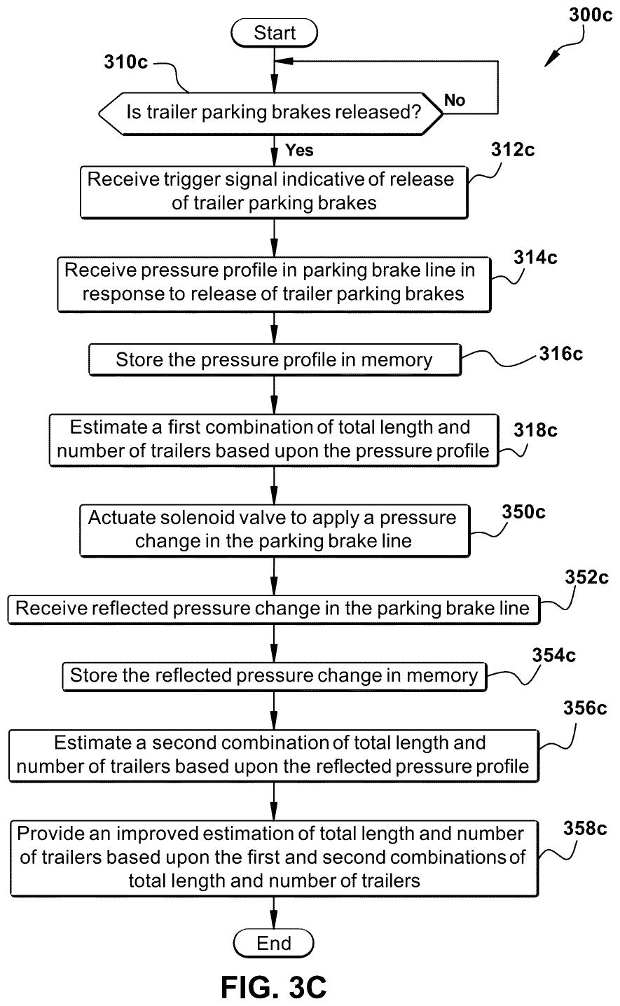

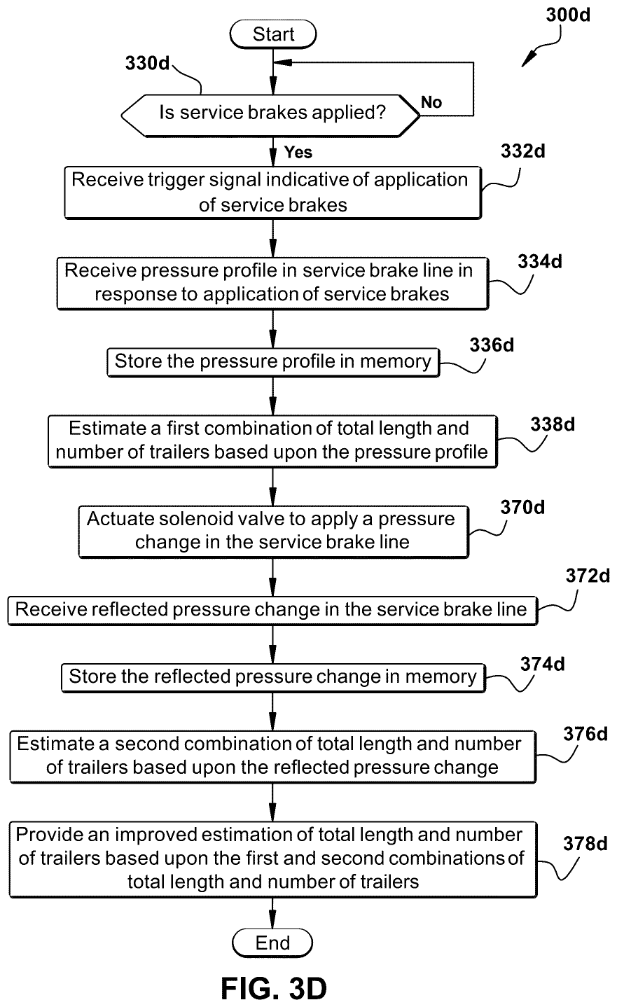

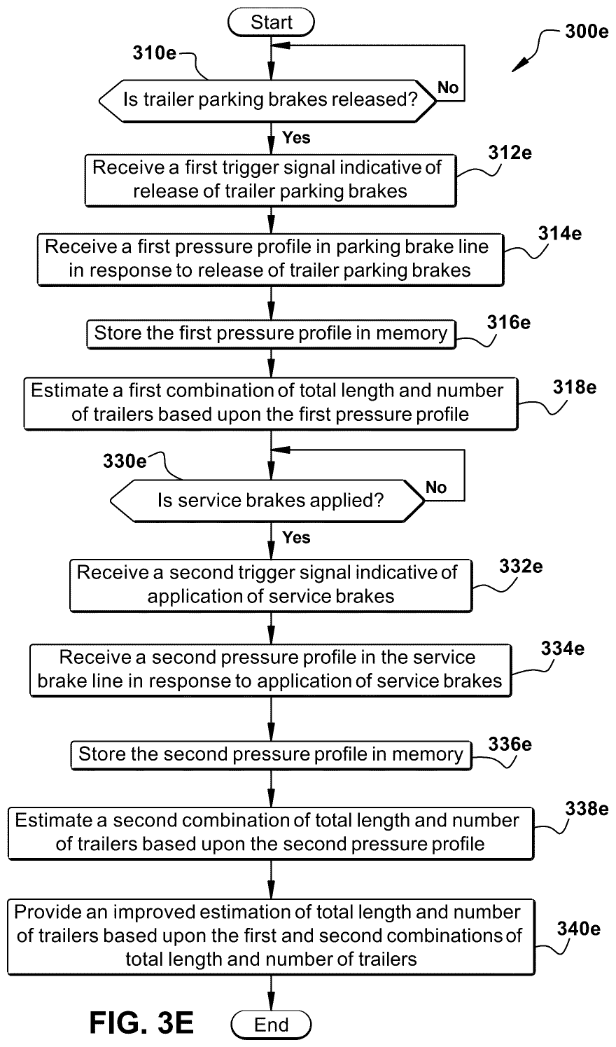

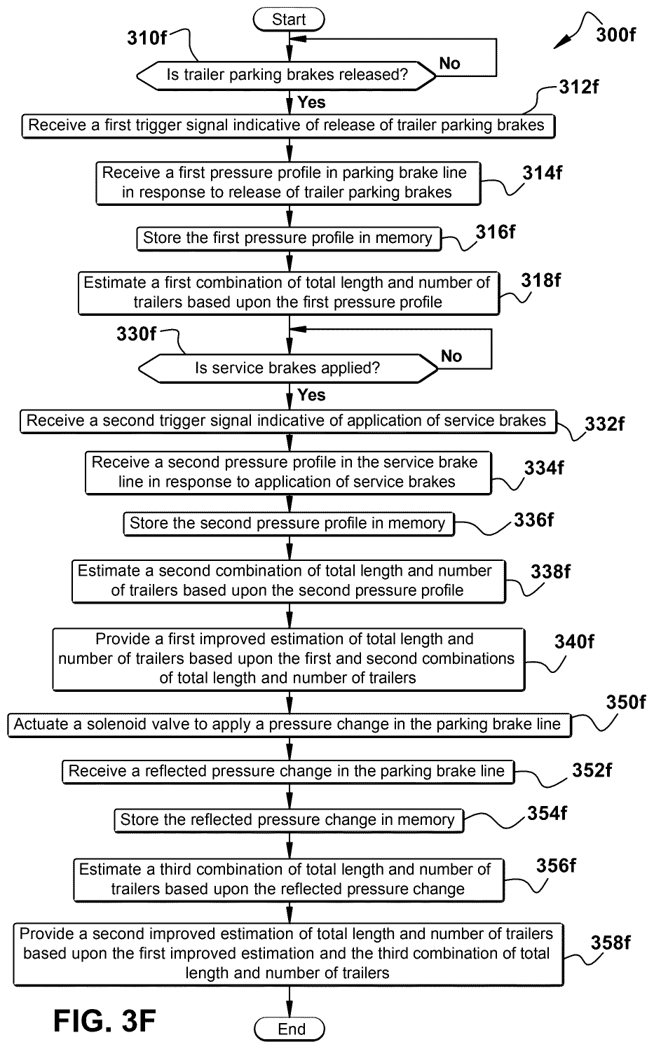

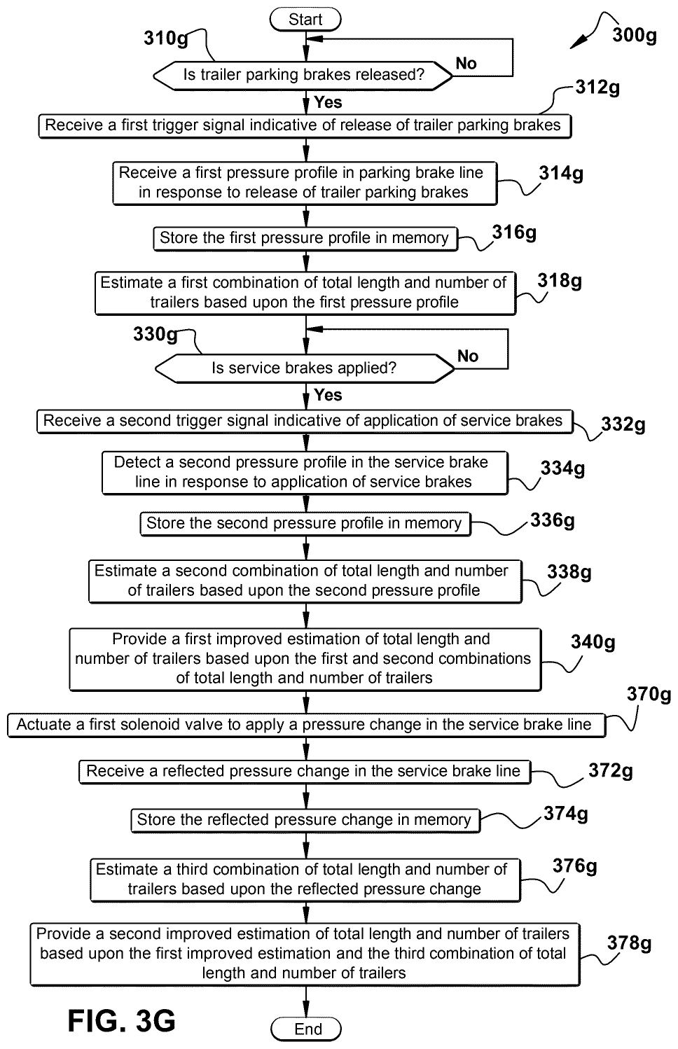

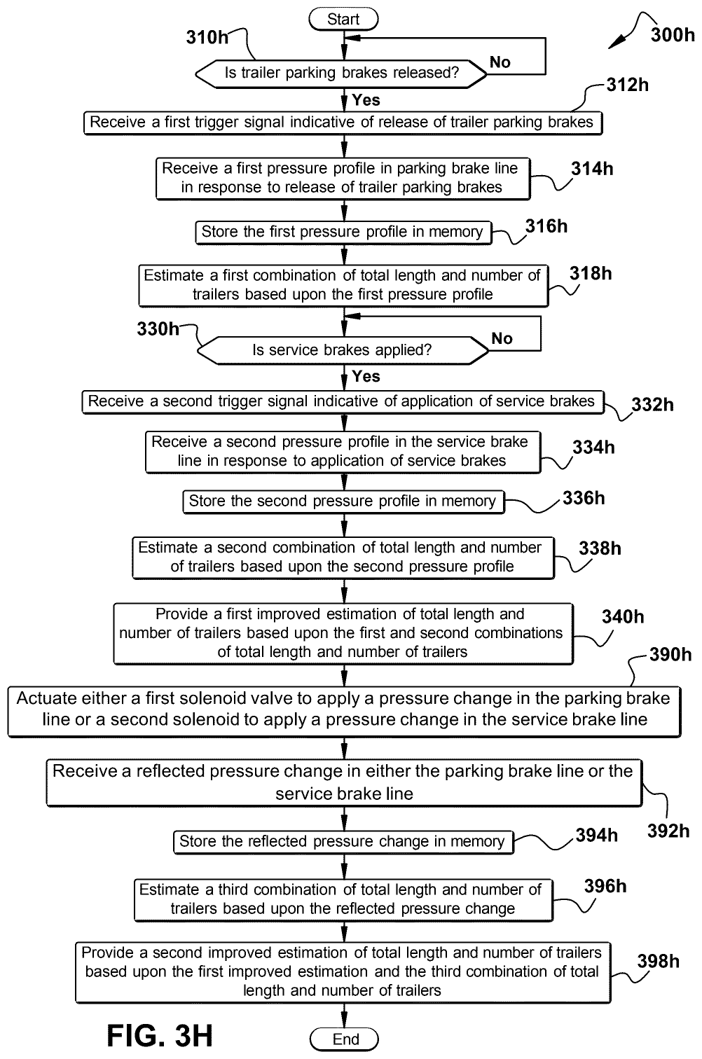

Referring to FIG. 3A, flow diagram 300a corresponds to the schematic block diagram of FIG. 2A, and depicts a method of operating tractor controller 110a of FIG. 2A in accordance with an embodiment. In block 310a, a determination is made as to whether trailer parking brakes of the vehicle train 1 is released. If the determination in block 310a is negative, the process returns loops back on itself to continue monitoring for a release of the trailer parking brakes. However, if the determination in block 310a is affirmative, the process proceeds to block 312a.

In block 312a, processor 112a receives trigger signal 142a via driver interface 140a indicative of release of the trailer parking brakes. Then in block 314a, processor 112a receives a pressure profile in parking brake line 12, via sensor interface 121a and pressure sensor 131a, in response to release of the trailer parking brakes. The pressure profile is stored in memory, such as memory 116a, as shown in block 316a. The process proceeds to block 318a.

In block 318a, an estimation is made of a combination of total length and number of trailers coupled to the tractor 100 based upon the pressure profile received. The estimation of the combination of total length and number of trailers may be presented via driver interface 140a as trailer length/number signal 144a to a display in the vehicle driver compartment for the vehicle driver to view. Trailer length/number signal 144a may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144a. The process of control logic 114a for tractor controller 110a then ends.

Referring to FIG. 2B, a schematic block diagram of an example tractor controller 110b (corresponding to tractor controller 110 of FIG. 1) in accordance with another embodiment is illustrated. Tractor controller 110b includes processor 112b that executes instructions of control logic 114b stored in internal memory 116b, external memory (not shown), or a combination thereof. Processor 112b may comprise any type of technology. For example, processor 112b may comprise a general-purpose electronic processor. Other types of processors and technologies are possible. Internal memory 116b may comprise any type of technology. For example, internal memory 116b may comprise random access memory (RAM), read only memory (ROM), solid state memory, or any combination thereof. Other types of memories and data storage technologies are possible.

Tractor controller 110b also includes vehicle sensor interface 122b that may comprise any type of technology. Sensor interface 122b enables communication between processor 112b and pressure sensor 132b, which is a transducer that detects pressure in service brake line 14. Tractor controller 110b communicates with vehicle driver interface 140b that may comprise any type of technology. Driver interface 140b enables communication between processor 112b and any combination of driver input devices and driver output devices (not shown) located in the vehicle driver compartment.

Driver input devices may comprise a parking brake handle for enabling the vehicle driver to apply/release parking brakes of the vehicle train 1 (FIG. 1), and a foot pedal for enabling the vehicle driver to apply/release the service brakes of the vehicle train 1. Other types of driver input devices and technologies are possible. As shown in FIG. 2B, driver interface 140b receives trigger signal 142b (from either the parking brake handle or the foot pedal, for example) that is communicated to processor 112b for further processing.

Driver output devices may comprise a display for enabling the vehicle information from processor 112b to be presented to the vehicle driver in the vehicle driver compartment. As shown in FIG. 2B, processor 112b provides trailer length/number signal 144b via driver interface 140b to the display in the vehicle driver compartment. Trailer length/number signal 144b is indicative of a combination of the number of trailers and a total length of the number of trailers (e.g., the first trailer 200 and/or the second trailer 300 shown in FIG. 1) coupled to the tractor 100.

Referring to FIG. 3B, flow diagram 300b corresponds to the schematic block diagram of FIG. 2B, and depicts a method of operating tractor controller 110b of FIG. 2B in accordance with an embodiment. In block 330b, a determination is made as to whether service brakes of the vehicle train 1 is applied. If the determination in block 330b is negative, the process returns loops back on itself to continue monitoring for an application of the service brakes. However, if the determination in block 330b is affirmative, the process proceeds to block 332b.

In block 332b, processor 112b receives trigger signal 142b via driver interface 140b indicative of application of the service brakes. Then in block 334b, processor 112b receives a pressure profile in service brake line 14, via sensor interface 122b and pressure sensor 132b, in response to application of the service brakes. The pressure profile is stored in memory, such as memory 116b, as shown in block 336b. The process proceeds to block 338b.

In block 338b, an estimation is made of a combination of total length and number of trailers coupled to the tractor 100 based upon the pressure profile received. The estimation of the combination of total length and number of trailers may be presented via driver interface 140b as trailer length/number signal 144b to a display in the vehicle driver compartment for the vehicle driver to view. Trailer length/number signal 144b may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144b. The process of control logic 114b for tractor controller 110b then ends.

Referring to FIG. 2C, a schematic block diagram of an example tractor controller 110c (corresponding to tractor controller 110 of FIG. 1) in accordance with another embodiment is illustrated. Tractor controller 110c includes processor 112c that executes instructions of control logic 114c stored in internal memory 116c, external memory (not shown), or a combination thereof. Processor 112c may comprise any type of technology. For example, processor 112c may comprise a general-purpose electronic processor. Other types of processors and technologies are possible. Internal memory 116c may comprise any type of technology. For example, internal memory 116c may comprise random access memory (RAM), read only memory (ROM), solid state memory, or any combination thereof. Other types of memories and data storage technologies are possible.

Tractor controller 110c includes solenoid valve 151c pneumatically connected to parking brake line 12, and electrically connected to processor 112c. Solenoid valve 151c may comprise a traction valve of the vehicle train 1. Traction valves are known and conventional and, therefore, will not be described.

Tractor controller 110c also includes vehicle sensor interface 121c that may comprise any type of technology. Sensor interface 121c enables communication between processor 112c and pressure sensor 131c, which is a transducer that detects pressure in parking brake line 12. Tractor controller 110c communicates with vehicle driver interface 140c that may comprise any type of technology. Driver interface 140c enables communication between processor 112c and any combination of driver input devices and driver output devices (not shown) located in the vehicle driver compartment.

Driver input devices may comprise a parking brake handle for enabling the vehicle driver to apply/release parking brakes of the vehicle train 1 (FIG. 1), and a foot pedal for enabling the vehicle driver to apply/release the service brakes of the vehicle train 1. Other types of driver input devices and technologies are possible. As shown in FIG. 2C, driver interface 140c receives trigger signal 142c (from either the parking brake handle or the foot pedal, for example) that is communicated to processor 112c for further processing.

Driver output devices may comprise a display for enabling the vehicle information from processor 112c to be presented to the vehicle driver in the vehicle driver compartment. As shown in FIG. 2C, processor 112c provides trailer length/number signal 144c via driver interface 140c to the display in the vehicle driver compartment. Trailer length/number signal 144c is indicative of a combination of the number of trailers and a total length of the number of trailers (e.g., the first trailer 200 and/or the second trailer 300 shown in FIG. 1) coupled to the tractor 100.

Referring to FIG. 3C, flow diagram 300c corresponds to the schematic block diagram of FIG. 2C, and depicts a method of operating tractor controller 110c of FIG. 2C in accordance with an embodiment. In block 310c, a determination is made as to whether trailer parking brakes of the vehicle train 1 is released. If the determination in block 310c is negative, the process returns loops back on itself to continue monitoring for a release of the trailer parking brakes. However, if the determination in block 310c is affirmative, the process proceeds to block 312c.

In block 312c, processor 112c receives trigger signal 142c via driver interface 140c indicative of release of the trailer parking brakes. Then in block 314c, processor 112c receives a pressure profile in parking brake line 12, via sensor interface 121c and pressure sensor 131c, in response to release of the trailer parking brakes. The pressure profile is stored in memory, such as memory 116c, as shown in block 316c. The process proceeds to block 318c.

In block 318c, an estimation is made of a first combination of total length and number of trailers coupled to the tractor 100 based upon the pressure profile received. The process then proceeds to block 350c in which solenoid valve 151c is actuated to provide a pressure change in the parking brake line 12 before proceeding to block 352c.

In block 352c, processor 112c receives a reflected pressure change in the parking brake line 12, via sensor interface 121c and pressure sensor 131c, in response to the applied pressure change in the parking brake line 12. The reflected pressure change is stored in memory, such as memory 116c, as shown in block 354c. The process proceeds to block 356c.

In block 356c, an estimation is made of a second combination of total length and number of trailers coupled to the tractor 100 based upon the reflected pressure change received. The process then proceeds to block 358c in which an improved estimation of total length and number of trailers coupled to the tractor 100 is provided. The improved estimation is based upon the first and second combinations of total length and number of trailers.

The improved estimation of total length and number of trailers may be presented via driver interface 140c as trailer length/number signal 144c to a display in the vehicle driver compartment for the vehicle driver to view. Trailer length/number signal 144c may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144c. The process of control logic 114c for tractor controller 110c then ends.

Referring to FIG. 2D, a schematic block diagram of an example tractor controller 110d (corresponding to tractor controller 110 of FIG. 1) in accordance with another embodiment is illustrated. Tractor controller 110d includes processor 112d that executes instructions of control logic 114d stored in internal memory 116d, external memory (not shown), or a combination thereof. Processor 112d may comprise any type of technology. For example, processor 112d may comprise a general-purpose electronic processor. Other types of processors and technologies are possible. Internal memory 116d may comprise any type of technology. For example, internal memory 116d may comprise random access memory (RAM), read only memory (ROM), solid state memory, or any combination thereof. Other types of memories and data storage technologies are possible.

Tractor controller 110d includes solenoid valve 152d pneumatically connected to service brake line 14, and electrically connected to processor 112d. Solenoid valve 152d may comprise a traction valve of the vehicle train 1. Traction valves are known and conventional and, therefore, will not be described.

Tractor controller 110d also includes vehicle sensor interface 122d that may comprise any type of technology. Sensor interface 122d enables communication between processor 112d and pressure sensor 132d, which is a transducer that detects pressure in service brake line 14. Tractor controller 110d communicates with vehicle driver interface 140d that may comprise any type of technology. Driver interface 140d enables communication between processor 112d and any combination of driver input devices and driver output devices (not shown) located in the vehicle driver compartment.

Driver input devices may comprise a parking brake handle for enabling the vehicle driver to apply/release parking brakes of the vehicle train 1 (FIG. 1), and a foot pedal for enabling the vehicle driver to apply/release the service brakes of the vehicle train 1. Other types of driver input devices and technologies are possible. As shown in FIG. 2D, driver interface 140d receives trigger signal 142d (from either the parking brake handle or the foot pedal, for example) that is communicated to processor 112d for further processing.

Driver output devices may comprise a display for enabling the vehicle information from processor 112d to be presented to the vehicle driver in the vehicle driver compartment. As shown in FIG. 2D, processor 112d provides trailer length/number signal 144d via driver interface 140d to the display in the vehicle driver compartment. Trailer length/number signal 144d is indicative of a combination of the number of trailers and a total length of the number of trailers (e.g., the first trailer 200 and/or the second trailer 300 shown in FIG. 1) coupled to the tractor 100.

Referring to FIG. 3D, flow diagram 300d corresponds to the schematic block diagram of FIG. 2D, and depicts a method of operating tractor controller 110d of FIG. 2D in accordance with an embodiment. In block 330d, a determination is made as to whether service brakes of the vehicle train 1 is applied. If the determination in block 330d is negative, the process returns loops back on itself to continue monitoring for an application of the service brakes. However, if the determination in block 330d is affirmative, the process proceeds to block 332d.

In block 332d, processor 112d receives trigger signal 142d via driver interface 140d indicative of application of the service brakes. Then in block 334d, processor 112d receives a pressure profile in service brake line 14, via sensor interface 122d and pressure sensor 132d, in response to application of the service brakes. The pressure profile is stored in memory, such as memory 116d, as shown in block 336d. The process proceeds to block 338d.

In block 338d, an estimation is made of a first combination of total length and number of trailers coupled to the tractor 100 based upon the pressure profile received. The process then proceeds to block 370d in which solenoid valve 152d is actuated to provide a pressure change in the service brake line 14 before proceeding to block 372d.

In block 372d, processor 112d receives a reflected pressure change in the service brake line 14, via sensor interface 122d and pressure sensor 132d, in response to the applied pressure change in the service brake line 14. The reflected pressure change is stored in memory, such as memory 116d, as shown in block 374d. The process proceeds to block 376d.

In block 376d, an estimation is made of a second combination of total length and number of trailers coupled to the tractor 100 based upon the reflected pressure change received. The process then proceeds to block 378d in which an improved estimation of total length and number of trailers coupled to the tractor 100 is provided. The improved estimation is based upon the first and second combinations of total length and number of trailers.

The improved estimation of total length and number of trailers may be presented via driver interface 140d as trailer length/number signal 144d to a display in the vehicle driver compartment for the vehicle driver to view. Trailer length/number signal 144d may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144d. The process of control logic 114d for tractor controller 110d then ends.

Referring to FIG. 2E, a schematic block diagram of an example tractor controller 110e (corresponding to tractor controller 110 of FIG. 1) in accordance with another embodiment is illustrated. FIG. 2E shows a variation of tractor controller 110a and tractor controller 110b shown in FIGS. 2A and 2B, respectively. Since the embodiment illustrated in FIG. 2E is generally similar to the embodiments illustrated in FIGS. 2A and 2B, similar numerals are utilized to designate similar components, the suffix letter “e” being associated with the embodiment of FIG. 2E to avoid confusion.

Components of tractor controller 110e of FIG. 2E comprise components of tractor controller 110a of FIG. 2A and components of tractor controller 110b of FIG. 2B. Components of tractor controller 110a of FIG. 2A and components of tractor controller 110b of FIG. 2B have been described hereinabove. Accordingly, components of tractor controller 110e of FIG. 2E will not be described.

Referring to FIG. 3E, flow diagram 300e corresponds to the schematic block diagram of FIG. 2E, and depicts a method of operating tractor controller 110e of FIG. 2E in accordance with an embodiment. In block 310e, a determination is made as to whether trailer parking brakes of the vehicle train 1 is released. If the determination in block 310e is negative, the process returns loops back on itself to continue monitoring for a release of the trailer parking brakes. However, if the determination in block 310e is affirmative, the process proceeds to block 312e.

In block 312e, processor 112e receives first trigger signal 142e via driver interface 140e indicative of release of the trailer parking brakes. Then in block 314e, processor 112e receives a first pressure profile in parking brake line 12, via first sensor interface 121e and pressure sensor 131e, in response to release of the trailer parking brakes. The first pressure profile is stored in memory, such as memory 116e, as shown in block 316e. The process proceeds to block 318e.

In block 318e, an estimation is made of a first combination of total length and number of trailers coupled to the tractor 100 based upon the first pressure profile received. The process proceeds to block 330e.

In block 330e, a determination is made as to whether service brakes of the vehicle train 1 is applied. If the determination in block 330e is negative, the process returns loops back on itself to continue monitoring for an application of the service brakes. However, if the determination in block 330e is affirmative, the process proceeds to block 332e.

In block 332e, processor 112e receives second trigger signal 143e via driver interface 140e indicative of application of the service brakes. Then in block 334e, processor 112e receives a second pressure profile in service brake line 14, via second sensor interface 122e and second pressure sensor 132e, in response to application of the service brakes. The second pressure profile is stored in memory, such as memory 116e, as shown in block 336e. The process proceeds to block 338e.

In block 338e, an estimation is made of a second combination of total length and number of trailers coupled to the tractor 100 based upon the second pressure profile received. The process proceeds to block 340e. In block 340e, an improved estimation of total length and number of trailers is calculated. The improved estimation is calculated based upon the first and second combinations.

The improved estimation of total length and number of trailers may be presented via driver interface 140e as trailer length/number signal 144e to a display in the vehicle driver compartment for the vehicle driver to view. Trailer length/number signal 144c may also be communicated to other vehicle controllers, such as the brake controller 16 (FIG. 1), to enable tractor braking as well as trailer braking to be adjusted based upon the improved estimation of total length and number of trailers coupled to the tractor 100, as indicated by trailer length/number signal 144e. The process of control logic 114e for tractor controller 110e then ends.

Referring to FIG. 2F, a schematic block diagram of an example tractor controller 110f (corresponding to tractor controller 110 of FIG. 1) in accordance with another embodiment is illustrated. FIG. 2F shows a variation of tractor controller 110b and tractor controller 110c shown in FIGS. 2B and 2C, respectively. Since the embodiment illustrated in FIG. 2F is generally similar to the embodiments illustrated in FIGS. 2B and 2C, similar numerals are utilized to designate similar components, the suffix letter “f” being associated with the embodiment of FIG. 2F to avoid confusion.

Components of tractor controller 110f of FIG. 2F comprise components of tractor controller 110b of FIG. 2B and components of tractor controller 110c of FIG. 2C. Components of tractor controller 110b of FIG. 2B and components of tractor controller 110c of FIG. 2C have been described hereinabove. Accordingly, components of tractor controller 110f of FIG. 2F will not be described.

Referring to FIG. 3F, flow diagram 300f corresponds to the schematic block diagram of FIG. 2F, and depicts a method of operating tractor controller 110f of FIG. 2F in accordance with an embodiment. In block 310f, a determination is made as to whether trailer parking brakes of the vehicle train 1 is released. If the determination in block 310f is negative, the process returns loops back on itself to continue monitoring for a release of the trailer parking brakes. However, if the determination in block 310f is affirmative, the process proceeds to block 312f.

In block 312f, processor 112f receives first trigger signal 142f via driver interface 140f indicative of release of the trailer parking brakes. Then in block 314f, processor 112f receives a first pressure profile in parking brake line 12, via first sensor interface 121f and pressure sensor 131f, in response to release of the trailer parking brakes. The first pressure profile is stored in memory, such as memory 116f, as shown in block 316f. The process proceeds to block 318f.

In block 318f, an estimation is made of a first combination of total length and number of trailers coupled to the tractor 100 based upon the first pressure profile received. The process proceeds to block 330f.

In block 330f, a determination is made as to whether service brakes of the vehicle train 1 is applied. If the determination in block 330f is negative, the process returns loops back on itself to continue monitoring for an application of the service brakes. However, if the determination in block 330f is affirmative, the process proceeds to block 332f.

In block 332f, processor 112f receives second trigger signal 143f via driver interface 140e indicative of application of the service brakes. Then in block 334e, processor 112f receives a second pressure profile in service brake line 14, via second sensor interface 122f and second pressure sensor 132f, in response to application of the service brakes. The second pressure profile is stored in memory, such as memory 116f, as shown in block 336f. The process proceeds to block 338f.

In block 338f, an estimation is made of a second combination of total length and number of trailers coupled to the tractor 100 based upon the second pressure profile received. The process proceeds to block 340f. In block 340f, a first improved estimation of total length and number of trailers is calculated. The improved estimation is calculated based upon the first and second combinations. The process proceeds to block 350f.

In block 350f, solenoid valve 151f is actuated to apply a pressure change in the parking brake line 12 before proceeding to block 352f. In block 352f, processor 112f receives a reflected pressure change in the parking brake line 12, via sensor interface 121f and pressure sensor 131f, in response to the applied pressure change in the parking brake line 12. The reflected pressure change is stored in memory, such as memory 116f, as shown in block 354f. The process proceeds to block 356f.

In block 356f, an estimation is made of a third combination of total length and number of trailers coupled to the tractor 100 based upon the reflected pressure change received. The process then proceeds to block 358f in which a second improved estimation of total length and number of trailers coupled to the tractor 100 is provided. The second improved estimation is based upon the first improved estimation and the third combination of total length and number of trailers.

The second improved estimation of total length and number of trailers may be presented via driver interface 140f as trailer length/number signal 144f to a display in the vehicle driver compartment for the vehicle driver to view. Trailer length/number signal 144f may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144f. The process of control logic 114f for tractor controller 110f then ends.

Referring to FIG. 2G, a schematic block diagram of an example tractor controller 110g (corresponding to tractor controller 110 of FIG. 1) in accordance with another embodiment is illustrated. FIG. 2F shows a variation of tractor controller 110a and tractor controller 110d shown in FIGS. 2A and 2D, respectively. Since the embodiment illustrated in FIG. 2G is generally similar to the embodiments illustrated in FIGS. 2A and 2D, similar numerals are utilized to designate similar components, the suffix letter “g” being associated with the embodiment of FIG. 2G to avoid confusion.

Components of tractor controller 110g of FIG. 2G comprise components of tractor controller 110a of FIG. 2A and components of tractor controller 110d of FIG. 2D. Components of tractor controller 110a of FIG. 2A and components of tractor controller 110d of FIG. 2D have been described hereinabove. Accordingly, components of tractor controller 110g of FIG. 2G will not be described.

Referring to FIG. 3G, flow diagram 300g corresponds to the schematic block diagram of FIG. 2G, and depicts a method of operating tractor controller 110g of FIG. 2G in accordance with an embodiment. In block 310g, a determination is made as to whether trailer parking brakes of the vehicle train 1 is released. If the determination in block 310g is negative, the process returns loops back on itself to continue monitoring for a release of the trailer parking brakes. However, if the determination in block 310g is affirmative, the process proceeds to block 312g.

In block 312g, processor 112g receives first trigger signal 142g via driver interface 140g indicative of release of the trailer parking brakes. Then in block 314g, processor 112g receives a first pressure profile in parking brake line 12, via first sensor interface 121g and pressure sensor 131g, in response to release of the trailer parking brakes. The first pressure profile is stored in memory, such as memory 116g, as shown in block 316g. The process proceeds to block 318g.

In block 318g, an estimation is made of a first combination of total length and number of trailers coupled to the tractor 100 based upon the first pressure profile received. The process proceeds to block 330g.

In block 330g, a determination is made as to whether service brakes of the vehicle train 1 is applied. If the determination in block 330g is negative, the process returns loops back on itself to continue monitoring for an application of the service brakes. However, if the determination in block 330g is affirmative, the process proceeds to block 332g.

In block 332g, processor 112g receives second trigger signal 143g via driver interface 140g indicative of application of the service brakes. Then in block 334g, processor 112g receives a second pressure profile in service brake line 14, via second sensor interface 122g and second pressure sensor 132g, in response to application of the service brakes. The second pressure profile is stored in memory, such as memory 116g, as shown in block 336g. The process proceeds to block 338g.

In block 338g, an estimation is made of a second combination of total length and number of trailers coupled to the tractor 100 based upon the second pressure profile received. The process proceeds to block 340g. In block 340g, a first improved estimation of total length and number of trailers is calculated. The first improved estimation is calculated based upon the first and second combinations. The process proceeds to block 370g.

In block 370g, solenoid valve 152g is actuated to provide a pressure change in the service brake line 14 before proceeding to block 372g. In block 372g, processor 112g receives a reflected pressure change in the service brake line 14, via sensor interface 122g and pressure sensor 132g, in response to the applied pressure change in the service brake line 14. The reflected pressure change is stored in memory, such as memory 116g, as shown in block 374g. The process proceeds to block 376g.

In block 376g, an estimation is made of a third combination of total length and number of trailers coupled to the tractor 100 based upon the reflected pressure change received. The process then proceeds to block 378g in which a second improved estimation of total length and number of trailers coupled to the tractor 100 is provided. The second improved estimation is based upon the first improved estimation and the third combination of total length and number of trailers.

The second improved estimation of total length and number of trailers may be presented via driver interface 140g as trailer length/number signal 144g to a display in the vehicle driver compartment for the vehicle driver to view. Trailer length/number signal 144g may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144g.

The second improved estimation of total length and number of trailers may be presented via driver interface 140g as trailer length/number signal 144g to a display in the vehicle driver compartment for the vehicle driver to view. Trailer length/number signal 144g may also be communicated to other vehicle controllers, such as the brake controller 16 (FIG. 1), to enable tractor braking as well as trailer braking to be adjusted based upon the improved estimation of total length and number of trailers coupled to the tractor 100, as indicated by trailer length/number signal 144g. The process of control logic 114g for tractor controller 110g then ends.

Referring to FIG. 2H, a schematic block diagram of an example tractor controller 110h (corresponding to tractor controller 110 of FIG. 1) in accordance with another embodiment is illustrated. FIG. 2H shows a variation of tractor controller 110f and tractor controller 110g shown in FIGS. 2F and 2G, respectively. Since the embodiment illustrated in FIG. 2H is generally similar to the embodiments illustrated in FIGS. 2F and 2G, similar numerals are utilized to designate similar components, the suffix letter “h” being associated with the embodiment of FIG. 2H to avoid confusion.

Components of tractor controller 110h of FIG. 2H comprise components of tractor controller 110f of FIG. 2F and components of tractor controller 110g of FIG. 2G. Components of tractor controller 110f of FIG. 2F and components of tractor controller 110g of FIG. 2G have been described hereinabove. Accordingly, components of tractor controller 110h of FIG. 2H will not be described.

Referring to FIG. 3H, flow diagram 300h corresponds to the schematic block diagram of FIG. 2H, and depicts a method of operating the brake control apparatus 10 of FIG. 1 in accordance with an embodiment. In block 310h, a determination is made as to whether trailer parking brakes of the vehicle train 1 is released. If the determination in block 310h is negative, the process returns loops back on itself to continue monitoring for a release of the trailer parking brakes. However, if the determination in block 310h is affirmative, the process proceeds to block 312h.

In block 312h, processor 112h receives first trigger signal 142h via driver interface 140h indicative of release of the trailer parking brakes. Then in block 314h, processor 112h receives a first pressure profile in parking brake line 12, via first sensor interface 121h and pressure sensor 131h, in response to release of the trailer parking brakes. The first pressure profile is stored in memory, such as memory 116h, as shown in block 316h. The process proceeds to block 318h.

In block 318h, an estimation is made of a first combination of total length and number of trailers coupled to the tractor 100 based upon the first pressure profile received. The process proceeds to block 330h.

In block 330h, a determination is made as to whether service brakes of the vehicle train 1 is applied. If the determination in block 330h is negative, the process returns loops back on itself to continue monitoring for an application of the service brakes. However, if the determination in block 330h is affirmative, the process proceeds to block 332h.

In block 332h, processor 112h receives second trigger signal 143h via driver interface 140h indicative of application of the service brakes. Then in block 334h, processor 112h receives a second pressure profile in service brake line 14, via second sensor interface 122h and second pressure sensor 132h, in response to application of the service brakes. The second pressure profile is stored in memory, such as memory 116h, as shown in block 336h. The process proceeds to block 338h.

In block 338h, an estimation is made of a second combination of total length and number of trailers coupled to the tractor 100 based upon the second pressure profile received. The process proceeds to block 340h. In block 340h, a first improved estimation of total length and number of trailers is calculated. The first improved estimation is calculated based upon the first and second combinations. The process then proceeds to block 390h.

In block 390h, either first solenoid valve 151h or second solenoid valve 152h is actuated to provide a corresponding pressure change in the parking brake line 12 or the service brake line 14 before proceeding to block 392h. In block 392h, processor 112g receives a reflected pressure change in either the parking brake line 12 via first sensor interface 121h and first pressure sensor 131h or the service brake line 14 via second sensor interface 122h and second pressure sensor 132h, in response to the applied pressure change. The reflected pressure change is stored in memory, such as memory 116h, as shown in block 394h. The process proceeds to block 396h.

In block 396h, an estimation is made of a third combination of total length and number of trailers coupled to the tractor 100 based upon the reflected pressure change received. The process then proceeds to block 398h in which a second improved estimation of total length and number of trailers coupled to the tractor 100 is provided. The second improved estimation is based upon the first improved estimation and the third combination of total length and number of trailers.

The second improved estimation of total length and number of trailers may be presented via driver interface 140h as trailer length/number signal 144h to a display in the vehicle driver compartment for the vehicle driver to view. Trailer length/number signal 144h may also be communicated to other vehicle controllers, such as the brake controller 16 (FIG. 1), to enable tractor braking as well as trailer braking to be adjusted based upon the combination of total length and number of trailers coupled to the tractor 100, as indicated by trailer length/number signal 144h. The process of control logic 114h for tractor controller 110h then ends.

Referring to FIG. 2I, a schematic block diagram of an example tractor controller 110i (corresponding to tractor controller 110 of FIG. 1) in accordance with another embodiment is illustrated. FIG. 2I shows a variation of tractor controller 110h shown in FIG. 2H. Since the embodiment illustrated in FIG. 2I is generally similar to the embodiment illustrated in FIG. 2H, similar numerals are utilized to designate similar components, the suffix letter “i” being associated with the embodiment of FIG. 2I to avoid confusion.

Tractor controller 110i of FIG. 2I comprises components of tractor controller 110h of FIG. 2H and additional backup components. Components of tractor controller 110h of FIG. 2H have been described hereinabove. The additional backup components shown in FIG. 2I include first backup sensor interface 123i which is backup to first sensor interface 121i, and second backup sensor interface 124i which is backup to second sensor interface 122i. The additional backup components shown in FIG. 2I further include first backup pressure sensor 133i which is backup to first pressure sensor 131i, and second backup pressure sensor 134i which is backup to second pressure sensor 132i. The additional backup components shown in FIG. 2I also include first backup solenoid valve 153i which is backup to first solenoid valve 151i, and second backup solenoid valve 154i which is backup to second solenoid valve 152i. Any combination of the additional backup components shown in FIG. 2I may be implemented. Additional backup components other than those shown in FIG. 2I are possible.

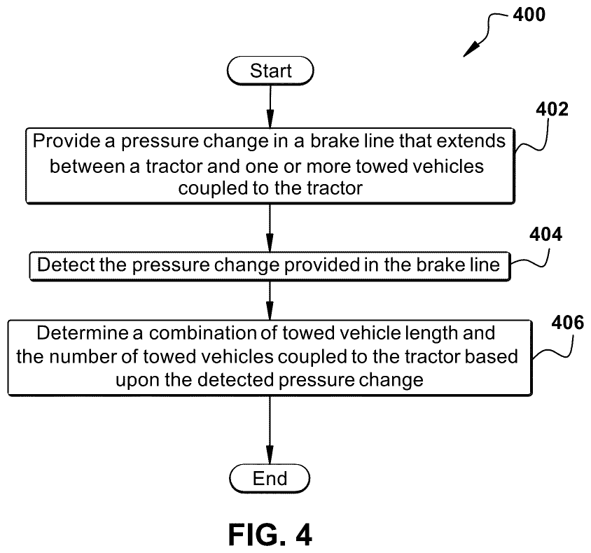

Referring to FIG. 4, flow diagram 400 depicts a method of operating the vehicle train 1 of FIG. 1 in accordance with an embodiment. In block 402, a pressure change is provided in a brake line that extends between the tractor and one or more towed vehicles coupled to the tractor. The process proceeds to block 404 in which the pressure change provided in the brake line is detected. Then in block 406, a determination is made of a combination of towed vehicle length and the number of towed vehicles coupled to the tractor based upon the detected pressure change. The process then ends.

In some embodiments, a pressure pulse is applied in the brake line, and a reflected pressure pulse is detected in the brake line after the pressure pulse has been applied in the brake line. In some embodiments, the applied pressure pulse and the reflected pressure pulse are compared to determine a pressure difference between the applied pressure pulse and the reflected pressure pulse. The pressure difference enables the combination of towed vehicle length and the number of towed vehicles coupled to the tractor to be determined.

In some embodiments, the method is performed by a controller having a memory executing one or more programs of instructions which are tangibly embodied in a program storage medium readable by the controller.

It should be apparent that the tractor controller 110 of FIG. 1 is arranged to detect a pressure change in either the parking brake line 12 or the service brake line 14 in response to a corresponding brake trigger signal. The detected pressure change is used to estimate the number of the towed vehicles or the total length of the number of towed vehicles, or both.

It should also be apparent that the tractor controller 110 of FIG. 1 is arranged to apply a pressure pulse in either the parking brake line 12 or the service brake line 14 using solenoid valves, and then to detect a reflected pressure pulse in the corresponding brake line in response to the applied pressure pulse. The reflected pressure pulse is used to estimate the number of the towed vehicles or the total length of the number of towed vehicles, or both.

A number of advantages result by providing a vehicle with the above-described tractor controller 110. One advantage is that tractor braking and trailer braking, or both, can be adjusted and optimized based upon the actual number of trailers coupled to the tractor. For example, the ability is provided to send braking requests to any number of specific axles or axle groups on any number of specific towed vehicles based upon the actual number of trailers in tow. The result is improved overall braking performance of the vehicle train 1.

Program instructions for enabling each of the tractor controller 110 of FIG. 1 to perform operation steps in accordance with corresponding flow diagrams may be embedded in memory internal to the tractor controller 110. Alternatively, or in addition to, program instructions may be stored in memory external to each respective controller. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one controller in the tractor 100, it is conceivable that any number of controllers may be used. Moreover, it is conceivable that any type of controller may be used. Suitable controllers for use in vehicles are known and, therefore, have not been described. Accordingly, the program instructions of the present disclosure can be stored on program storage media associated with one or more vehicle controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A brake control apparatus for a vehicle train having a tractor one or more towed vehicles coupled to the tractor, the brake control apparatus comprising:
a tractor controller arranged to (i) detect a pressure change in at least one brake line of the vehicle train in response to a brake trigger signal, and (ii) process the detected pressure change to estimate a combination of the number of the towed vehicles and a total length of the number of towed vehicles coupled to the tractor.

2. The brake control apparatus according to claim 1, wherein the at least one brake line of the vehicle train comprises a combination of a parking brake line and a service brake line.

3. The brake control apparatus according to claim 1, wherein the at least one brake line of the vehicle train comprises a parking brake line associated with the one or more towed vehicles, and the brake trigger signal is provided in response to release of parking brakes associated with the one or more towed vehicles.

4. The brake control apparatus according to claim 1, wherein the at least one brake line of the vehicle train comprises a service brake line associated with the one or more towed vehicles, and the brake trigger signal is provided in response to application of service brakes associated with the one or more towed vehicles.

5. The brake control apparatus according to claim 1, wherein the at least one brake line of the vehicle train comprises a parking brake line associated with the one or more towed vehicles and a service brake line associated with the one or more towed vehicles, and the brake trigger signal is provided in response to either release of parking brakes associated with the one or more towed vehicles or application of service brakes associated with the one or more towed vehicles.

6. The brake control apparatus according to claim 1 further comprising:
a first pressure sensor for sensing a first pressure change in a first brake line of the at least one brake line of the vehicle train in response to a first brake trigger signal; and
a second pressure sensor for sensing a second pressure change in a second brake line of the at least one brake line of the vehicle train in response to a second brake trigger signal which is different from the first brake trigger signal.

7. The brake control apparatus according to claim 1 further comprising:
an actuatable first solenoid valve for, when actuated, providing a first pressure change in a first brake line of the at least one brake line of the vehicle train; and
a first pressure sensor for sensing a first reflected pressure change in the first brake line after the first solenoid valve is actuated to provide the first pressure change in the first brake line.

8. The brake control apparatus according to claim 7 further comprising:
an actuatable second solenoid valve for, when actuated, providing a second pressure change in a second brake line of the at least one brake line of the vehicle train; and
a second pressure sensor for sensing a second reflected pressure change in the second brake line after the second solenoid valve is actuated to provide the second pressure change in the second brake line.

9. The brake control apparatus according to claim 7 further comprising:
an actuatable second solenoid valve for, when actuated, providing a second pressure change in the first brake line, wherein the first solenoid valve acts as a primary solenoid valve and the second solenoid valve acts as a secondary solenoid valve backing up the primary solenoid valve.

10. The brake control apparatus according to claim 9 further comprising:
a second pressure sensor for sensing a second reflected pressure change in the first brake line, wherein the first pressure sensor acts as a primary pressure sensor and the second pressure sensor acts as a secondary pressure sensor backing up the primary pressure sensor.

11. A brake control apparatus for a vehicle train having a tractor and one or more towed vehicles coupled to the tractor, the brake control apparatus comprising:
a brake line extending between the tractor and the one or more towed vehicles; and
a tractor controller arranged to (i) apply a pressure pulse in the brake line, (ii) detect a reflected pressure pulse in the brake line in response to the applied pressure pulse, and (iii) determine the number of towed vehicles coupled to the tractor based upon the reflected pressure pulse detected in the brake line.

12. The brake control apparatus according to claim 11, wherein the brake line extending between the tractor and the one or more towed vehicles comprises a select one of a parking brake line and a service brake line.

13. The brake control apparatus according to claim 11, wherein the tractor controller is arranged to process the reflected pressure pulse to determine a total length value that is used to calculate the number of towed vehicles coupled to the tractor.

14. The brake control apparatus according to claim 11 further comprising:
at least one actuatable solenoid valve for, when actuated, applying the pressure pulse in the brake line.

15. The brake control apparatus according to claim 14, wherein the at least one actuatable solenoid valve comprises a traction valve of the vehicle train.

16. The brake control apparatus according to claim 11 further comprising:
at least one actuatable solenoid valve for, when actuated, applying the pressure pulse in the brake line; and
at least one transducer for sensing the reflected pressure pulse in the brake line and providing a signal indicative thereof.

17. The brake control apparatus according to claim 16, wherein (i) the at least one actuatable solenoid valve includes a first solenoid valve that acts as a primary solenoid valve and a second solenoid that acts as a secondary solenoid valve backing up the primary solenoid valve, and (ii) the at least one transducer includes a first pressure sensor that acts as a primary pressure sensor and a second pressure sensor that acts as a secondary pressure sensor backing up the primary pressure sensor.

18. A method of operating a vehicle train having a tractor and one or more towed vehicles coupled to the tractor, the method comprising:
providing a pressure change in a brake line that extends between the tractor and the one or more towed vehicles coupled to the tractor;
detecting the pressure change provided in the brake line; and
determining a combination of towed vehicle length and the number of towed vehicles coupled to the tractor based upon the detected pressure change.

19. The method according to claim 18 wherein (i) providing a pressure change in a brake line includes applying a pressure pulse in the brake line, and (ii) detecting the pressure change provided in the brake line includes detecting a reflected pressure pulse in the brake line after the pressure pulse has been applied in the brake line.

20. The method according to claim 19 further comprising:
comparing the applied pressure pulse and the reflected pressure pulse to determine a pressure difference between the applied pressure pulse and the reflected pressure pulse and thereby to enable the combination of towed vehicle length and the number of towed vehicles coupled to the tractor to be determined.

21. The method according to claim 18, wherein the method is performed by a controller having a memory executing one or more programs of instructions which are tangibly embodied in a program storage medium readable by the controller.
